(19) United States
(12) Patent Application Publication
(10) Pub. No.: US 2003/0217625 A1
(43) Pub. Date: Nov. 27, 2003

(54) Method and apparatus for sizing stator wedge slides

(76) Inventors: Kenneth J. Hatley, Madison, NJ (US); Richard M. Hatley, Madison, NJ (US); Michael J. Bousquet, Hewitt, NJ (US)

Correspondence Address: Kevin T. Duncan, Esq., Hunton & Williams, Suite 1200, 1900 K Street, NW, Washington, DC, 20006-1109, US

(21) Appl. No.: 10/151,919

(22) Filed: May 22, 2002

(51) Int. Cl. B26D 1/56

(52) U.S. Cl. 83/37; 83/78

(57) ABSTRACT

An apparatus is provided for sizing a stator wedge slide having a wedge-shaped profile. The apparatus includes a support bed for supporting the slide; a slide cutter for cutting the slide; a slide positioner for positioning the slide relative to the slide cutter; and a thickness gauge for determining a thickness of the slide. A position of a first cut is located based on a first thickness determined by the thickness gauge.

### BACKGROUND OF THE INVENTION

Embodiments of the invention relate to the production of wedges. More particularly, embodiments of the invention relate to the production of stator wedge slides for turbines.

### SUMMARY OF THE INVENTION

The invention provides, among other things, solutions to problems associated with the production of turbine stator wedge slides.

Examples of the invention include an apparatus for sizing a stator wedge slide having a wedge-shaped profile. The apparatus includes a support bed for supporting the slide; a slide cutter for cutting the slide; a slide positioner for positioning the slide relative to the slide cutter; and a thickness gauge for determining a thickness of the slide. A position of a first cut is located based on a first thickness determined by the thickness gauge.

Other examples of the invention include a method of sizing a stator wedge slide having a wedge-shaped profile. The method includes supporting the slide on a support bed; positioning the slide at a first cutting position relative to a slide cutter with a slide positioner; cutting the slide at the first cutting position with the slide cutter; positioning the slide at a second cutting position; and cutting the slide at the second cutting position with the slide cutter. The first cutting position is located based on a first thickness of the slide determined by a thickness gauge.

These and other features of the invention will be readily apparent to those skilled in the art upon reading this disclosure in connection with the attached drawing figures.

### BRIEF DESCRIPTION OF THE DRAWINGS

FIG. 1 is an example of a stator in which slides made in accordance with the invention can be used;

FIG. 2 is a side view of an example of an embodiment of the invention prior to positioning of the slide;

FIG. 3 is a side view of the example shown in FIG. 2 after initial positioning of the slide;

FIG. 4 is a side view of the example shown in FIG. 2 during initial cutting of the slide;

FIG. 5 is a side view of the example shown in FIG. 2 after initial cutting of the slide;

FIG. 6 is a side view of the example shown in FIG. 2 after secondary positioning of the slide; and

FIG. 7 is a side view of the example shown in FIG. 2 during secondary cutting of the slide.

### DETAILED DESCRIPTION OF THE INVENTION

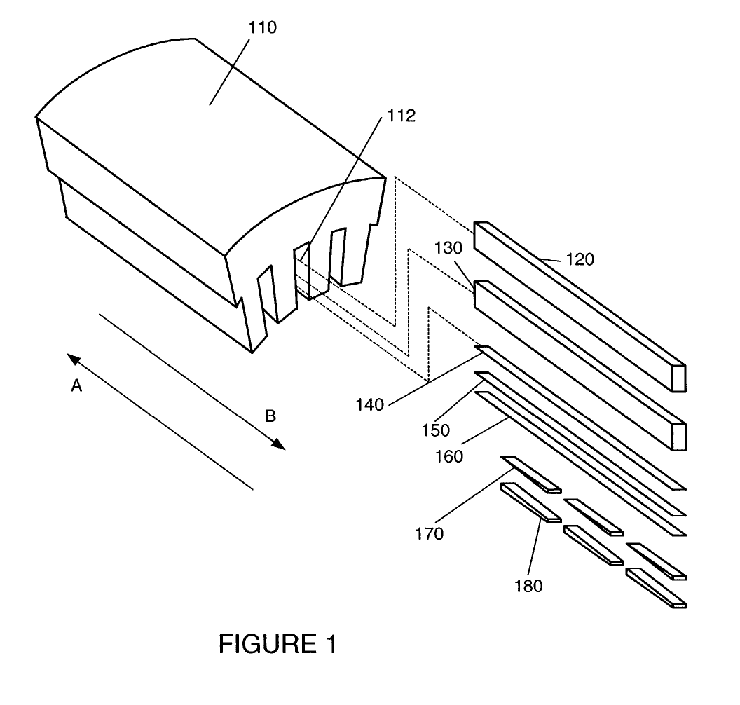

FIG. 1 shows an example of a portion of an electric generator stator in which slides made in accordance with embodiments of the invention can be used. FIG. 1 shows electric generator stator 110 and the associated pieces that fit in one of the slots 112 of stator 110. An outer stator bar 120, an inner stator bar 130, one or more slot fillers 140, 150, and a top ripple spring 160 are held in place by stator wedge slides 170 and stator wedges 180. Moving stator wedge slides 170 in the direction of arrow A relative to stator wedges 180, or moving stator wedges 180 in the direction of arrow B relative to stator wedge slides 170, applies pressure to outer stator bar 120 and inner stator bar 130 in a direction that tends to keep outer stator bar 120 and inner stator bar 130 in slot 112. It is critical that stator wedge slides 170 are sized appropriately to apply the desired pressure when installed.

One procedure for installing a stator wedge includes placing the wedge in a slot and sliding a stator wedge slide between the wedge and the slot contents. In order to obtain slides of the correct thickness, blank slides are manufactured longer than the required length of the installed slide and sections are trimmed off both the thick end and the thin end of the slide to obtain a slide of the desired thickness. One method of obtaining the correct thickness slide is to gauge by hand the distance between the wedge and the ripple spring and then hand cut each individual slide to the required thickness. Other methods of determining the required slide size exist, such as, for example, the systems and methods disclosed in U.S. patent application Ser. No. 09/741,893, filed Dec. 20, 2000, which is incorporated herein by reference.

Embodiments of the invention provide an automated wedge slide cutter. Particular embodiments of the invention can receive measurement data obtained from systems and methods such as, for example, those disclosed in U.S. patent application Ser. No. 09/741,893. Systems and methods of the invention, particularly when used in conjunction with measuring devices similar to those discussed above, can reduce (1) the down time associated with stator wedging; (2) prevent rework due to procedure nonconformances, gauging variation, and errors in hand sizing and cutting each slide to length; and (3) ensure that the stator slot support system assembly is consistently tight.

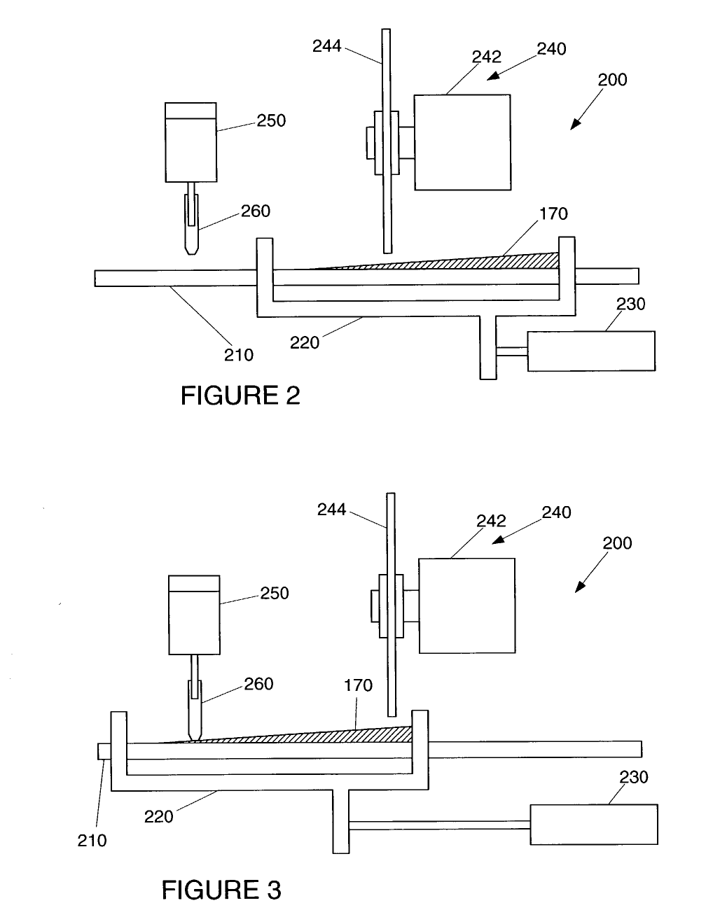

FIGS. 2-7 show an example of a slide cutting apparatus in accordance with embodiments of the invention. The example of the apparatus 200 shown in FIG. 2 has a support bed 210 that is used to support a stator wedge slide 170 while it is being cut to a desired length and thickness. A slide positioner 220 is provided for positioning slide 170 during cutting. Slide positioner 220 can be moved relative to support bed 210 by a movement device such as, for example, air ram 230. A saw 240 having a saw motor 242 and a saw blade 244 is provided for cutting slide 170. A thickness stop 260 attached to a servo motor 250 is provided for determining a thickness of slide 170.

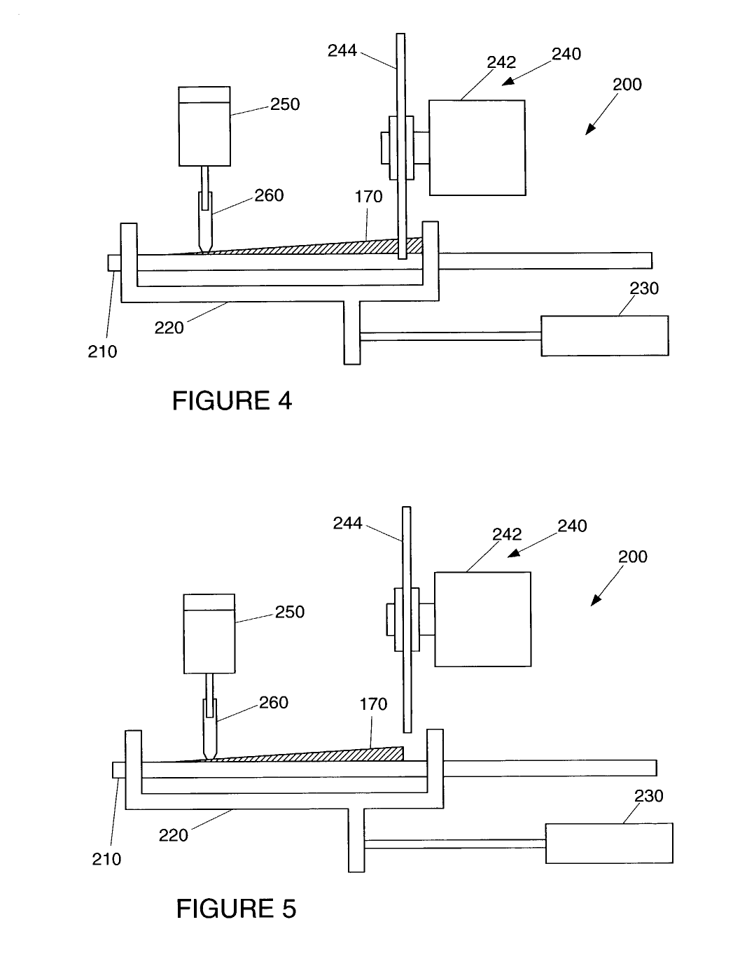

A blank slide 170 is initially positioned on support bed 210 and held in position by slide positioner 220. FIG. 3 shows thickness stop 260 in contact with an upper surface of slide 170. The horizontal distance between thickness stop 260 and saw blade 244 is known as well as the slope of the upper surface of slide 170. As a result, the thickness of slide 170 at the horizontal position of saw blade 244 can be determined by the thickness of slide 170 at the horizontal position of thickness stop 260. In particular embodiments, air ram 230 provides a precisely controlled amount of force on slide positioner 220 that is, in turn, transmitted to slide 170. As thickness stop 260 is raised or lowered, slide positioner 220 and slide 170 are allowed to move horizontally to the left or are pushed horizontally to the right respectively. In FIG. 3, slide 170 is held by thickness stop 260 in the appropriate position relative to saw blade 244 such that when saw blade 244 is lowered (FIG. 4) slide 170 is cut to an appropriate thickness.

FIG. 5 shows saw blade 244 retracted and the cut off portion of slide 170 removed.

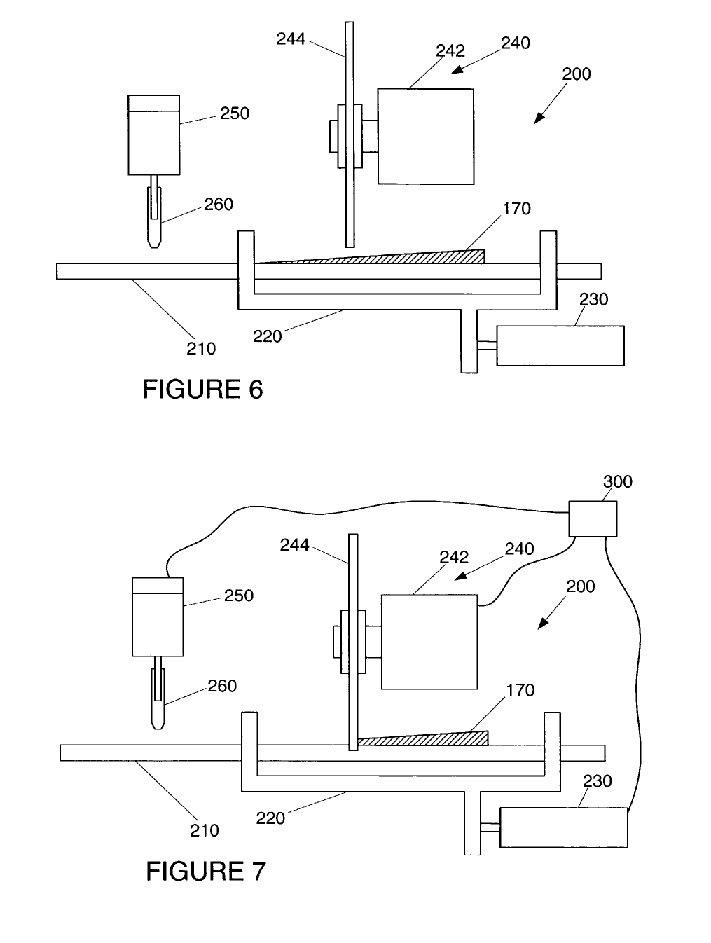

FIG. 6 shows air ram 230 in a retracted position which pulls slide positioner 220 to the right which, in turn, moves slide 170 to the right relative to saw blade 244. Air ram 230 is retracted a distance that will position saw blade 244 a predetermined distance from the thick end of slide 170. As shown in FIG. 7 saw blade 144 is then lowered into contact with slide 170 to trim slide 170 to its final length.

In preferred embodiments, the measurement data required by the invention can be provided by measurement devices such as those discussed above to a processor 300 that controls air ram 230, saw 240, and thickness stop 260.

Although the example depicted in the figures utilizes a rotary saw blade, it is noted that any appropriate cutting apparatus can be used. For example, cutters utilizing a reciprocating saw blade, a laser, or high pressure fluid may be appropriate. In addition, although the example depicted in the figures utilizes an air ram for positioning slide positioner 220, it is noted that any appropriate slide positioning device can be used. While particular embodiments and elements have been used to explain the apparatuses and methods of the invention, it is noted that other embodiments and elements in accordance with this spirit of the invention will be apparent to those skilled in the art upon review of this disclosure.

What is claimed is:

1. An apparatus for sizing a stator wedge slide having a wedge-shaped profile, comprising:
a support bed for supporting the slide;
a slide cutter for cutting the slide;
a slide positioner for positioning the slide relative to the slide cutter; and
a thickness gauge for determining a thickness of the slide,
wherein a position of a first cut is located based on a first thickness determined by the thickness gauge.

2. The apparatus of claim 1, wherein a position of a second cut is determined based on the position of the first cut.

3. The apparatus of claim 1, wherein the first thickness is located at a first thickness position, and
the position of the first cut is different than the first thickness position.

4. The apparatus of claim 3, wherein a position of a second cut is determined based on the position of the first cut.

5. The apparatus of claim 4, wherein the position of the second cut is a predetermined distance from the position of the first cut to result in the slide having a predetermined length.

6. The apparatus of claim 3, wherein the position of the first cut is determined based on the first thickness, the first thickness position, and a slope of an upper surface of the slide relative to the support bed.

7. The apparatus of claim 1, wherein the slide positioner moves relative to the support bed to position the slide relative to the support bed.

8. The apparatus of claim 7, wherein the slide positioner is moved relative to the support bed by an air ram.

9. The apparatus of claim 7, wherein the slide positioner is moved relative to the support bed by a hydraulic ram.

10. The apparatus of claim 1, wherein the thickness gauge and the slide cutter are fixed relative to each other in a longitudinal direction of the slide.

11. The apparatus of claim 10, wherein the thickness gauge, the slide cutter, and the support bed are fixed relative to each other in the longitudinal direction of the slide.

12. The apparatus of claim 11, wherein the slide positioner is movable relative to the slide cutter in the longitudinal direction of the slide.

13. The apparatus of claim 1, further comprising a processor,
wherein the processor determines the position of the first cut and the position of the second cut based on input received from an external source.

14. A method of sizing a stator wedge slide having a wedge-shaped profile, the method comprising:
supporting the slide on a support bed;
positioning the slide at a first cutting position relative to a slide cutter with a slide positioner;
cutting the slide at the first cutting position with the slide cutter;
positioning the slide at a second cutting position; and
cutting the slide at the second cutting position with the slide cutter,
wherein the first cutting position is located based on a first thickness of the slide determined by a thickness gauge.

15. The method of claim 14, wherein the second cutting position is determined based on the first cutting position.

16. The method of claim 14, wherein the first thickness is located at a first thickness position, and
the first cutting position is different than the first thickness position.

17. The method of claim 16, wherein the second cutting position is determined based on the first cutting position.

18. The method of claim 17, wherein the second cutting position is a predetermined distance from the first cutting position to result in the slide having a predetermined length.

19. The method of claim 16, wherein the first cutting position is determined based on the first thickness, the first thickness position, and a slope of an upper surface of the slide relative to the support bed.

20. The method of claim 14, wherein the slide positioner moves relative to the support bed to position the slide relative to the support bed.

21. The method of claim 20, wherein the slide positioner is moved relative to the support bed by an air ram.

22. The method of claim 20, wherein the slide positioner is moved relative to the support bed by a hydraulic ram.

23. The method of claim 14, wherein the thickness gauge and the slide cutter are fixed relative to each other in a longitudinal direction of the slide.

24. The method of claim 23, wherein the thickness gauge, the slide cutter, and the support bed are fixed relative to each other in the longitudinal direction of the slide.

25. The method of claim 24, wherein the slide positioner is movable relative to the slide cutter in the longitudinal direction of the slide.

26. The method of claim 14, wherein a processor determines the first cutting position and the second cutting position based on input received from an external source.
